(19) United States
(12) Patent Application Publication
(10) Pub. No.: US 2011/0247504 A1
(43) Pub. Date: Oct. 13, 2011

(54) PERFORATED VESSEL FOR FOOD PREPARATION

(76) Inventors: Giovanni Zangrande, Hong Kong (CN); Elizabeth Jheeta, Hong Kong (CN); Lea Ashfield, Hong Kong (CN)

(21) Appl. No.: 12/757,701

(22) Filed: Apr. 9, 2010

(51) Int. Cl. A47J 43/00

(52) U.S. Cl. 99/357; 99/450

(57) ABSTRACT

A device for cooking an edible item includes a sidewall having an upper end and a lower end, the sidewall defining an interior chamber and the lower end of the sidewall defining a lower opening; a perforated bottom wall coupled to the lower end of the sidewall, the bottom wall moveable between: a closed position in which the perforated bottom wall is configured to block the lower opening to maintain an item within the interior chamber; and an open position in which the bottom wall is configured to permit dispensing of the item from the interior chamber; and a control operative to cause the bottom wall to move from the closed position to the open position; where the device is a cooking device and the item is an edible item.

### BACKGROUND

The present invention relates generally to the field of cooking equipment. The present invention relates specifically to perforated vessels used for the preparation of food in heated or boiling water.

Cooking various food items (e.g., pasta, vegetables, fruit, meat, fish, shellfish, etc.) by immersion in heated or boiling water is a common food preparation method. In some cooking methods, the boiling water is contained in a vessel (e.g., pot, pan, sauce pan, stock pot, dutch oven, etc.), and the food item is retrieved or extracted from the boiling water when cooking is complete. The retrieval of cooked food is normally a cumbersome part of the process, because the cook is exposed to heat from the cooking range, hot cooking vessels, boiling water, etc., and, as a result, contact with the hot cooking range, with hot cooking vessels, and with hot water (e.g., spillage, splashing, etc., of hot water) from cooking vessels is a common cause of domestic accidents.

In addition, the time it takes various food items to cook (i.e., cooking times) depends on various properties of the food. For example, cooking time may depend on the type of food, the size of the food (e.g., long and short pasta formats, small and large potatoes, small or large pieces of chopped food, etc.). Cooking time may also vary according to individual preferences. For instance, pasta can be cooked “al dente” or for a longer period of time to acquire a softer consistency. Some foods, in particular those with relatively short cooking times, like pasta, may be particularly susceptible to overcooking if retrieval or removal of the food item from the heated water takes too long. Thus, prompt removal of the food item from the heated water may be important to preserving the individually preferred consistency of the cooked food.

A number of common tools and methods can be used for the retrieval of cooked food from boiling water including, forks, ladles, slotted spoons and similar hand tools as well as various “pour in” draining devices, such as colanders. Hand tools allow the retrieval of individual pieces of cooked food from cooking vessels. Hand tools may be used when boiling food, like potatoes or other vegetables, that have irregular sizes and that require slightly different cooking times depending on the size variations. Colanders are more commonly used when the whole contents of the cooking vessel are to be retrieved at the same time, as in the case of pasta. Colanders are typically used by placing the colander in a sink, by removing the cooking vessel from the heat source (e.g., a cooking range) and by pouring both the food item and the heated water from the cooking vessel into the colander. The perforations in the colander allow the water to drain from the colander into the sink while the solid food is retained within the colander. Thus, use of a colander requires that the user lift, transport and pour a cooking vessel containing heated water. Further, because the entire contents of the cooking vessel are poured into the colander at once, preparation of foods requiring different cooking times may require the use of multiple, separate cooking vessels, resulting in unneeded use of energy and water and increased complexity of the cooking process.

Other devices are known for facilitating the cooking of food using heated water. For example, some draining devices are positioned within the cooking vessel before or immediately after the water is heated. For some draining devices, when cooking of the food is completed, the draining device is lifted out of the cooking vessel and the food within the draining device is poured from the draining device as desired by the user. For some other draining devices, both the draining device and the cooking vessel containing the heated water may be moved to the sink prior to removal of the food from the heated water.

### SUMMARY

In one aspect, a device is provided for cooking an edible item. The device may include a sidewall having an upper end and a lower end, the sidewall defining an interior chamber and the lower end of the sidewall defining a lower opening; a perforated bottom wall coupled to the lower end of the sidewall, the bottom wall moveable between: a closed position in which the perforated bottom wall is configured to block the lower opening to maintain an item within the interior chamber; and an open position in which the bottom wall is configured to permit dispensing of the item from the interior chamber; and a control operative to cause the bottom wall to move from the closed position to the open position; where the device is a cooking device and the item is an edible item. In some embodiments, the sidewall and the bottom wall includes a material that is metal mesh, plastic mesh, perforated metal or perforated plastic. In some embodiments, the device also includes at least one hook extending from the sidewall configured to engage the rim of a cooking vessel. In some embodiments, the device also includes at least one foot extending below the bottom wall configured to support and separate the bottom wall of the device from a bottom of a cooking vessel. In some embodiments, the device also includes a handle rotatably coupled to the sidewall such that the handle may be folded in the radial direction about the sidewall. In some embodiments, the device also includes at least one hole defined in the handle, the hole sized to measure a serving the edible item. In some embodiments, the serving of the edible item comprises a serving of pasta. In some embodiments, the bottom wall is coupled to the sidewall via a hinge.

In some embodiments, the device also includes a latch extending longitudinally along the sidewall, the latch having a lower end and an upper end, wherein the lower end of the latch engages the bottom wall and the control engages the upper end of the latch when operated to cause the lower end of the latch to disengage from the bottom wall, and further wherein the bottom wall rotates about the hinge to move from the closed position to the open position when the lower end of the latch disengages from the bottom wall. In some embodiments, the control includes a button and an actuator that engages the upper end of the latch when operated by the user. In some embodiments, the button includes a spring that biases the actuator away from engagement with the latch. In some embodiments, the spring, the button and the actuator are formed of an integral piece of material.

In another aspect, a set of devices for holding food during cooking is provided, including, a first device that includes a sidewall having an upper end and a lower end, the sidewall defining an interior chamber and the lower end of the sidewall defining a lower opening; a perforated bottom wall coupled to the lower end of the sidewall, the bottom wall moveable between: a closed position in which the bottom wall blocks the lower opening maintaining food within the interior chamber; and an open position in which the bottom wall permits dispensing of food from the interior chamber; and a control operative to cause the bottom wall to move from the closed position to the open position; and a second device including: a sidewall having an upper end and a lower end, the sidewall defining an interior chamber and the lower end of the sidewall defining a lower opening; a perforated bottom wall coupled to the lower end of the sidewall, the bottom wall moveable between: a closed position in which the bottom wall blocks the lower opening maintaining food within the interior chamber; and an open position in which the bottom wall permits dispensing of food from the interior chamber; and a control operative to cause the bottom wall to move from the closed position to the open position; wherein the sidewall of the first device is sized such that the sidewall of the second device fits within the interior chamber of the first device. In some embodiments, the sidewall of the first device is substantially semi-circular in shape and the sidewall of the second device is substantially quarter-circular in shape. It is to be noted that “substantially semi-circular” or “substantially quarter-circular” are intended to refer to a broad spectrum of shapes and do not define the exact geometrical form. In one embodiment, the first device is substantially semi-circular and there are two additional devices which are substantially quarter-circular.

Alternative exemplary embodiments relate to other features and combinations of features as may be generally recited in the claims.

### BRIEF DESCRIPTION OF THE FIGURES

FIGS. 1A and 1B are perspective views of a perforated vessel, according to an exemplary embodiment.

FIG. 2A is an exploded view of the handle of the perforated vessel of FIGS. 1A-B, according to an exemplary embodiment.

FIG. 2B is a detailed view of the button of the perforated vessel, according to an exemplary embodiment.

FIG. 3A is a front perspective view of a perforated vessel in a closed bottom state, according to an exemplary embodiment.

FIG. 3B is a rear perspective view of a perforated vessel in a closed bottom state, according to an exemplary embodiment.

FIG. 3C is a sectional perspective view of the handle of the perforated vessel of FIGS. 3A-B, according to an exemplary embodiment.

FIG. 3D is an enlarged view of the latch of the perforated vessel of FIGS. 3A-B engaged with the bottom wall, according to an exemplary embodiment.

FIG. 4A is a front perspective view of the perforated vessel in an open bottom state, according to an exemplary embodiment.

FIG. 4B is a rear perspective view of the perforated vessel in an open bottom state, according to an exemplary embodiment.

FIG. 4C is an enlarged view of the latch of the perforated vessel of FIGS. 4A-B disengaged from the bottom wall, according to an exemplary embodiment.

FIG. 4D is a sectional perspective view of the handle of the perforated vessel of FIGS. 4A-B, according to an exemplary embodiment.

FIGS. 5A and 5B illustrate the folding of the handle of the perforated vessel, according to an exemplary embodiment.

FIG. 6A is a perspective view of a set of perforated vessels showing small sized perforated vessels nested within a perforated vessel of a larger size, according to an exemplary embodiment.

FIG. 6B is a perspective view of multiple perforated vessels positioned within a cooking vessel, with the handles in a storage position, according to an exemplary embodiment.

FIG. 6C is a perspective view of a set of perforated vessels showing small sized perforated vessels nested within a perforated vessel of a larger size, according to an exemplary embodiment.

FIG. 7 is a top perspective view of a cooking vessel illustrating a perforated vessel support by the rim of the cooking vessel, according to an exemplary embodiment.

FIG. 8 is a perspective view of one of the perforated vessels of FIG. 7 following removal from the cooking vessel and opening of the bottom, according to an exemplary embodiment.

### DETAILED DESCRIPTION

Before turning to the figures, which illustrate the exemplary embodiments in detail, it should be understood that the application is not limited to the details or methodology set forth in the description or illustrated in the figures. It should also be understood that the terminology is for the purpose of description only and should not be regarded as limiting.

Referring generally to the figures, a device (e.g., a perforated vessel) for holding solid food (pasta, vegetables, fruit, meat, fish, shellfish, etc.) during cooking in water (e.g., heated or boiling water) is shown. The perforated vessel includes a handle and a bottom wall or bottom panel that is moveable between a closed position and an open position. In the exemplary embodiment shown in the figures, the position of the bottom wall of the vessel is controlled by a button located on the handle. Movement of the bottom wall from the closed position to the open position may be useful in dispensing food items from the interior chamber of the perforated vessel directly to a container, such as a bowl or a plate.

The handle may include guides for measuring dry servings of spaghetti and other long pasta. The handle is coupled to the body or sidewall of the device via a hinge allowing the handle to rotate or fold about the hinge in the radial direction. The perforated vessel can be equipped with feet extending from the lower edges of the sidewalls of the perforated vessels below the bottom wall. The feet may allow for proper water circulation underneath the perforated vessel during cooking. In the embodiment shown in the figures, the perforated vessel includes hooks or brackets extending from one or more of the sidewalls of the perforated vessel. The hooks are shaped to engage the rim or lip of a cooking vessel (e.g., pot, pan, sauce pan, stock pot, dutch oven, etc.) to allow suspension of the perforated vessel from the rim of a cooking vessel such that the perforated vessel is positioned above the internal cavity or chamber of the cooking vessel.

In addition, the figures depict a method of positioning smaller-sized perforated vessels within a larger sized perforated vessel and a method of arranging foldable handles of perforated vessels relative to the outer-most edges of the perforated vessels. Such devices and methods may be useful to minimize the space occupied during storage and transportation of a set of the perforated vessels.

When a set of various sized perforated vessels is used together in the same cooking vessel, individual portions of food can be measured through the guides in the handle and kept separated with one portion of food in each perforated vessel. This separation allows the individual portions of food to be cooked within one cooking vessel while preventing intermixing of the individual portions of food while cooking. Once the portion in a perforated vessel is deemed ready (i.e., cooking of the portion is complete), the perforated vessel can be lifted from the cooking vessel and suspended from the rim of the cooking vessel by placing the hooks over the rim of the cooking vessel. In this position, the hot water is allowed to drain from the perforated vessel and from the food back into the cooking vessel. At the same time, if the portions of food contained within the other perforated vessels require further cooking, the other perforated vessels may remain immersed in the boiling water within the internal cavity of the cooking vessel. This allows the user to regulate cooking times of the portions of food within each perforated vessel according to the nature of different food portions or individual tastes. Providing the user with the ability to regulate cooking times of multiple food portions while using a single cooking vessel may reduce both fuel and water consumption.

After the water is drained, the suspended perforated vessel may be lifted such that the hooks disengage from the rim of the cooking vessel, and the perforated vessel can be moved directly over a container (plate, bowl, etc.) and the bottom wall of the perforated vessel can be opened or released through a latch mechanism controlled by the button on the handle. This allows for direct dispensing of the individual portion of cooked food from the perforated vessel to the container.

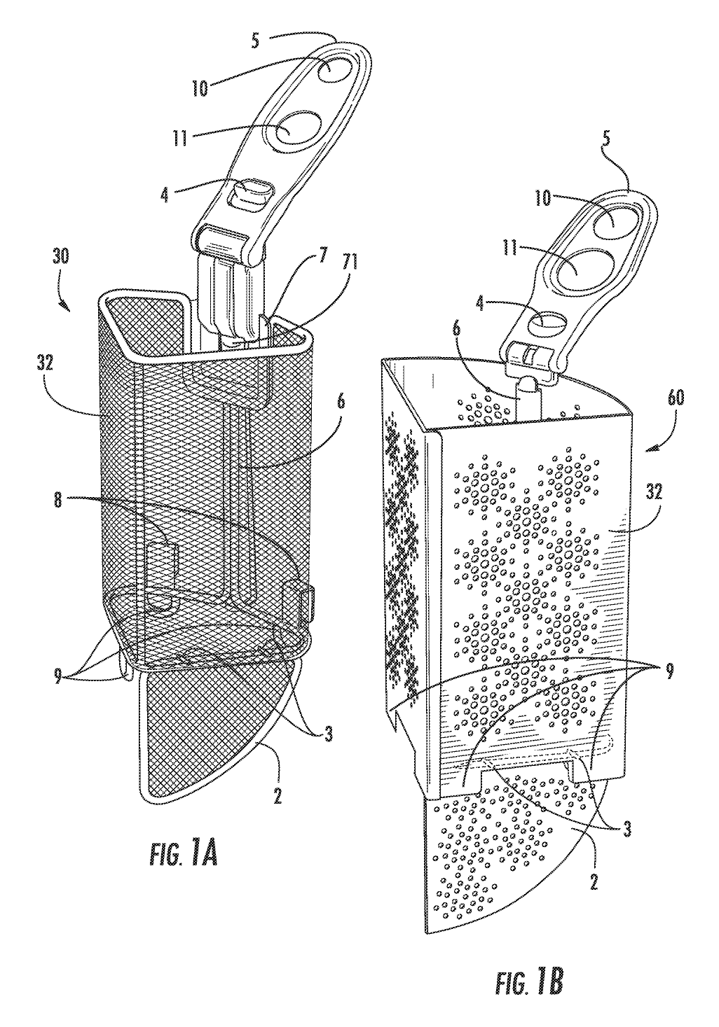

Referring to FIGS. 1A and 1B, a device for holding food during cooking in heated or boiling water is shown, according to various exemplary embodiments. In the embodiment of FIG. 1A, a perforated vessel 30 is shown made of wire mesh, and in the embodiment of FIG. 1B, a perforated vessel 60 is shown made of perforated sheet of material (e.g., sheet metal). According to other embodiments, the perforated vessel can be made of other material such as perforated plastic, plastic mesh, etc. In various embodiments, the spaces or perforations in the wire mesh of vessel 30 and the perforations of vessel 60 have a maximum inner dimension of about 1.5 mm (which is just smaller than the average diameter of spaghetti) to prevent food larger than this dimension from passing through the spaces or perforations.

According to other exemplary embodiments, the inner dimension of the spaces or perforations in wire mesh of vessel 30 or the perforations of vessel 60 may be larger or smaller than 1.5 mm as needed for various cooking applications, such that a food item being cooked may be retained within the vessel without falling through the inner dimension of the space or perforation. For example, the spaces in the wire mesh of vessel 30 may be greater than or less than 1.5 mm, and the perforations of vessel 60 may be greater than or less than 1.5 mm. The pattern of the spaces in the wire mesh of vessel 30 and of the perforations of vessel 60 may be the pattern shown in FIGS. 1A-B, or, in other embodiments, the pattern of the spaces in the wire mesh of vessel 30 and of the perforations of vessel 60 may be of any other pattern that prevents solid food from escaping the perforated vessel.

In the embodiments shown in the Figures, the perforated vessels are shown as either a generally quarter-circular or semi-circular shape (i.e., the cross-section of the vessel taken perpendicular to the longitudinal axis of the vessel is either quarter-circular or semi-circular). However, in other embodiments, the perforated vessels may be any other shape. For example, in some embodiments, the vessel may be square, rectangular, elliptical, triangular, trapezoidal, etc. In yet other embodiments, each vessel may define a portion of an arc on an outer wall, such that two (each being a semi-circle), three, four, five, six, seven, or eight vessels may be used in a single cooking vessel, the shapes will complement one another to fill the space of a cooking vessel.

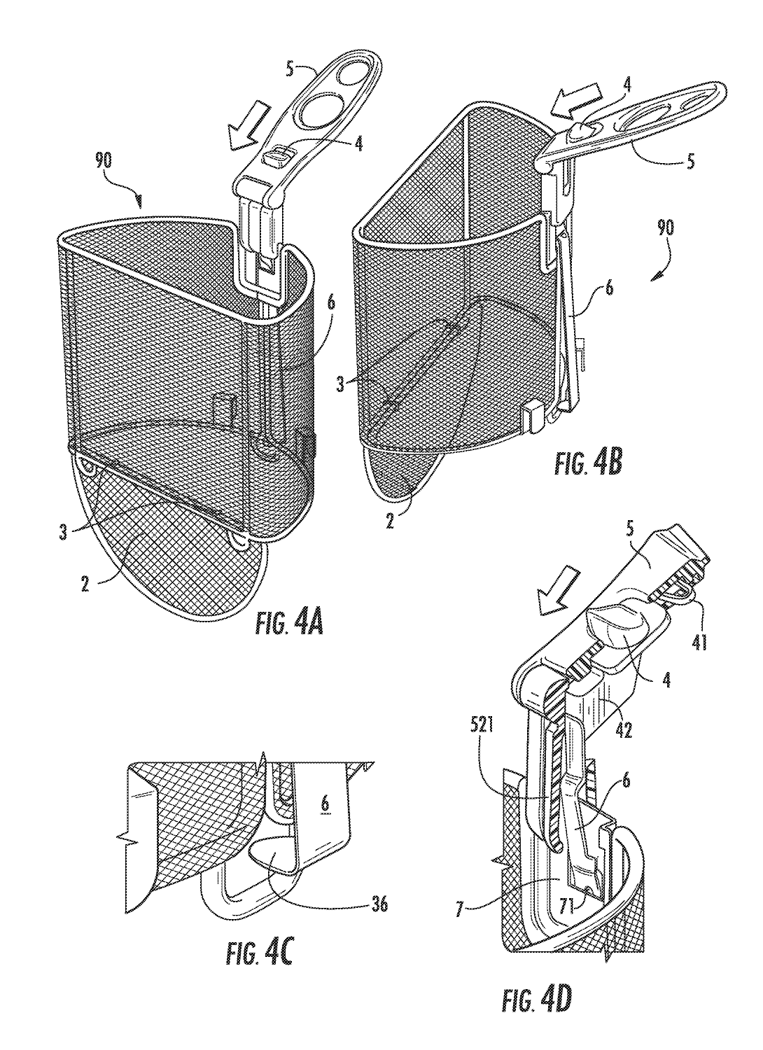

The perforated vessels 30 and 60 include a bottom wall 2 and hinges 3 that attach the bottom wall 2 to the lower end or edge of sidewall 32. Sidewall 32 defines an interior chamber of the perforated vessels 30 and 60. Bottom wall 2 is moveable between a closed position and an open position shown in FIGS. 1A and 1B. The upper end of sidewall 32 defines an upper opening and the lower edge of sidewall 32 defines a lower opening that is blocked or covered by bottom wall 2 in the closed position such that food is maintained within the interior chamber of the vessel. The bottom wall is moveable between the closed position and the open position. The perforated vessel includes a control, shown as button 4, that is operative to cause the bottom wall to move from the closed position to the open position. The position of bottom wall 2 is controlled by the button 4 via an interaction between button 4 and a latch 6. As shown, latch 6 is an integral piece of material that extends longitudinally along the outer surface of the sidewall 32. As shown in FIG. 4D, the latch 6 is shown pivoting around a latch locator 71 integrated in the mount plate 7 for the handle 5 of the perforated vessel.

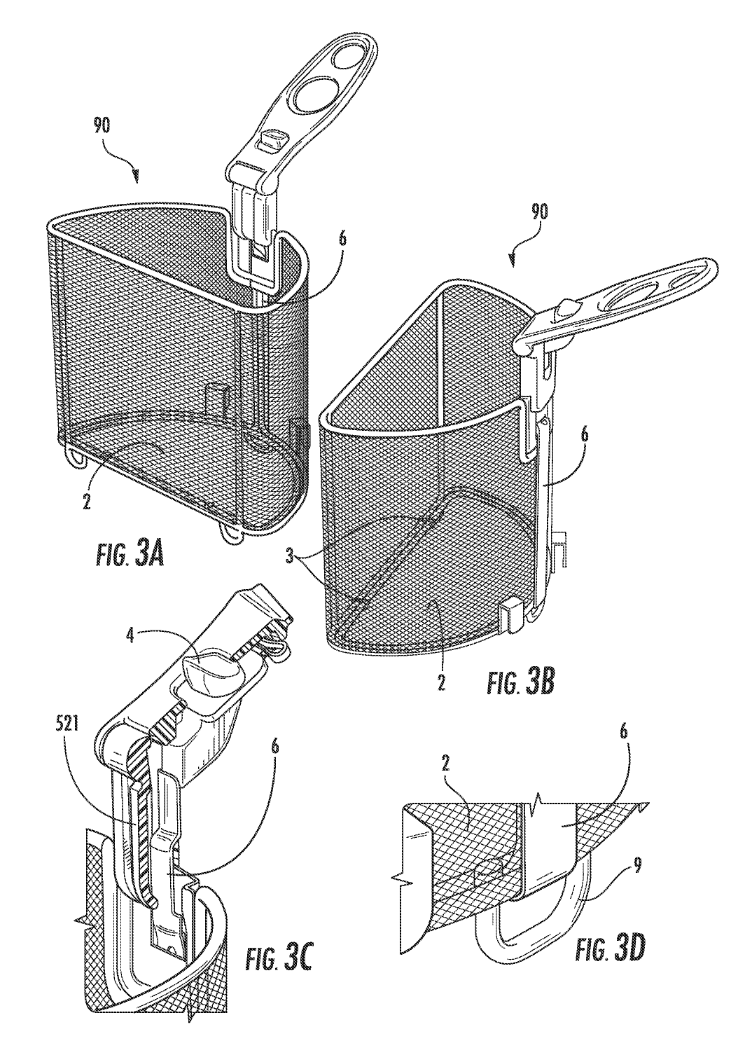

The handle 5 may be optionally equipped with holes 10 and 11 that serve as a guide for measuring dry servings of spaghetti, other long pasta, or other food to be cooked in the perforated vessel. As shown, the body of handle 5 defines holes 10 and 11. In the embodiment shown, two holes 10 and 11 located in the handle 5 are used, but the number of holes in the handle 5 can vary. The diameter of the holes 10 and 11 can vary in accordance with the capacity of the perforated vessel to which handle 5 is attached. For example, in one embodiment shown in FIG. 1A, a “small” perforated vessel may have an approximate quarter-circular shape and capacity for holding one serving of food. In this embodiment, the handle of the perforated vessel will include holes 10 and 11, and holes 10 and 11 may correspond to specific serving sized portions of food. For example, the larger hole 11 can be sized for one adult-sized serving of food, and the smaller hole 10 can be sized for one child-sized serving of food. In another embodiment, a “large” perforated vessel may have an approximately semi-circular section (as shown, for example, in FIGS. 3A-B) and a capacity for two servings of food. In this embodiment, the handle will carry holes corresponding to another specific serving sized portion of food. For example, small hole 11 can correspond to one adult-sized serving of food and the larger hole 11 can correspond to two adult-size servings of food. According to other exemplary embodiments, various other combinations of shapes, capacities and measuring guides may be used.

The perforated vessel can be further equipped with hooks 8 to allow suspension over of the perforated vessel from the rim of cooking vessels. As shown, hooks 8 are generally u-shaped having a lower surface configured to engage the rim of a cooking vessel allowing perforated vessel 30 to be supported above the cooking vessel by hooks 8. Perforated vessel 30 includes three or more feet 9 to support vessel 30 above the bottom wall of a cooking vessel. Feet 9 provide a space between bottom wall 2 and the bottom wall of the cooking vessel (i.e., feet 9 separate bottom wall 2 from the bottom of the cooking vessel) allowing for water circulation underneath the perforated vessel during cooking. Feet 9 are sized to allow enough space for the proper circulation of water and thermal agitation through and beneath the perforated vessels during cooking.

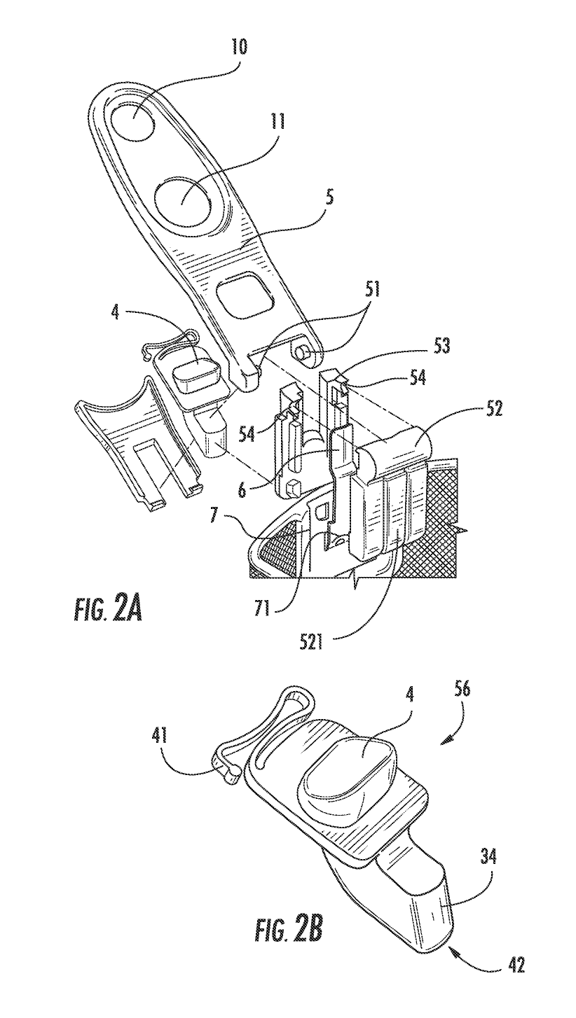

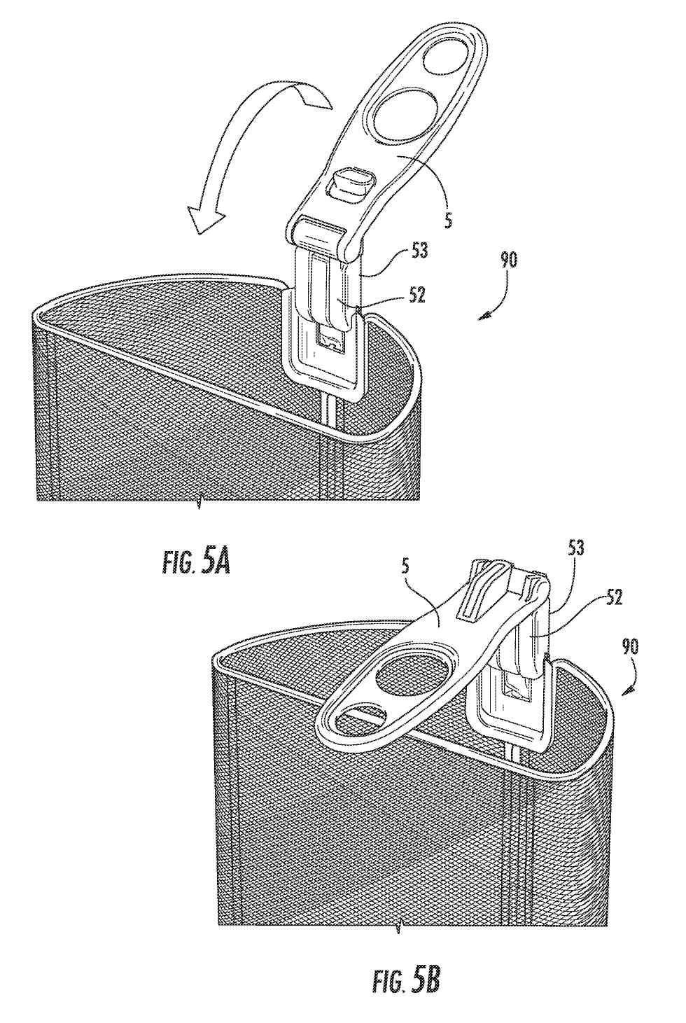

Referring to FIG. 2A, the handle 5 of the perforated vessel is shown in greater detail. The handle 5 includes two holes or apertures 10 and 11 that serve as a guide for measuring dry portions of long pasta or other food. As discussed above, holes 10 and 11 are of different sizes allowing for measurement of different sized portions of food. The handle 5 further includes two opposite studs or posts 51, fitting in the seats 54 of a front mount 52 and a rear mount 53. Posts 51 are rotatably received with mounts 52 and 53 to allow the radial folding of the handle 5 over the upper rim of the perforated vessel (see for example FIGS. 5A-B). The perforated vessel includes a latch retainer 521 that is part of the front mount 52. In other embodiments, handle 5 may be coupled to mounts 52 and 53 via any other suitable rotatable hinge connections. In one embodiment, handle 5 is made from a thermo-resistant plastic, and in other embodiments, the handle is made from other materials such as metal.

The handle 5 further includes a control mechanism 56. The control mechanism 56 includes a button 4 for operation of the bottom wall 2 of the perforated vessel, a spring 41 and an actuator 42. The button 4 is shown as part of a control element that is integral with the spring 41 and the actuator 42. As shown, actuator 42 is structure extending radially inward and below button 4. Actuator 42 has an engagement surface 34 that engages the latch 6 when button 4 is pressed causing the latch 6 to disengage from bottom wall 2. As explained in more detail below, bottom wall 2 is allowed to swing from the closed position to the open position when latch 6 disengages from the bottom wall 2.

Referring now to FIGS. 3A-D, a semi-circular perforated vessel 90 is shown with bottom wall 2 in the closed position. FIGS. 3A-B illustrate the bottom wall 2 in a closed position. In the closed position, the bottom wall 2 is maintained in the closed position by the engagement between a radially inwardly extending section of the lower end of latch 6 and a portion of bottom wall 2 as shown in FIG. 3D. In the embodiment shown in FIGS. 3A-3D, latch 6 engages the edge of bottom wall 2 opposite of the edge having hinges 3. The upper end of latch 6 is received within and is retained in position relative to button 4 via latch retainer 521, as shown in FIG. 3C.

Referring now to FIGS. 4A-D, the perforated vessel 90 is shown with bottom wall 2 in the open position. By applying a forward motion to the button 4 located on the handle 5 the spring 41 expands and the actuator 42 acts on the top part of the latch 6 moving it towards the center of the perforated vessel. As shown in FIG. 4D, as actuator 42 acts on the top portion of latch 6, the latch 6 forces the latch retainer 521 to flex inwardly toward the center of the vessel. The latch 6 pivots around the latch locator 71, which is part of the mount plate 7, such that the bottom or lower portion of the latch 6 (i.e., the portion of latch 6 below latch locator 71) is moved outwardly, away from the center of the perforated vessel (as shown in FIG. 4C). As latch 6 moves outwardly the lower horizontal section 36 of latch 6 disengages from the edge of bottom wall 2. With section 36 disengaged from bottom wall 2, the bottom wall 2 is free to rotate via the hinges 3 and will open under the combined weight of the bottom wall 2 itself and of any food contained within the perforated vessel. As a result, the cooked food held within the perforated vessel can be dispensed onto a container (e.g., plate, bowl, etc.) positioned beneath the perforated vessel by pressing button 4.

Also referring to FIGS. 4A-D and FIG. 3C, when the user ceases the application of force to button 4, the spring 41 retracts or contracts, returning the button 4 to the original button position (i.e. the position shown in FIG. 3C). As button 4 moves to the rest position, actuator 42 disengages from latch 6, and the latch retainer 521 returns to its un-flexed rest state, rotating the latch 6 in the opposite direction around the latch locator 71 back to the original closed position shown in FIG. 3C. Following dispensing of food from vessel 90, vessel 90 may be moved from the open position to the closed position by manually rotating bottom wall 2 from the open position to the closed position and by releasing the latch 6 such that section 36 re-engages below bottom wall 2.

Referring now to FIGS. 5A-B, an illustration of the radial folding of an individual handle 5 over the upper rim of end of the perforated vessel 90 is shown. As discussed above regarding FIG. 2A, handle 5 is rotatably coupled to mounts 52 and 53. This arrangement allows the radial folding of the handle 5 over the upper rim of the vessel as shown in FIGS. 5A-B. By reducing the lateral dimension of vessel 90, the folding of the handle 5 reduces the space occupied by the perforated vessel during transportation, storage, dish-washing, etc.

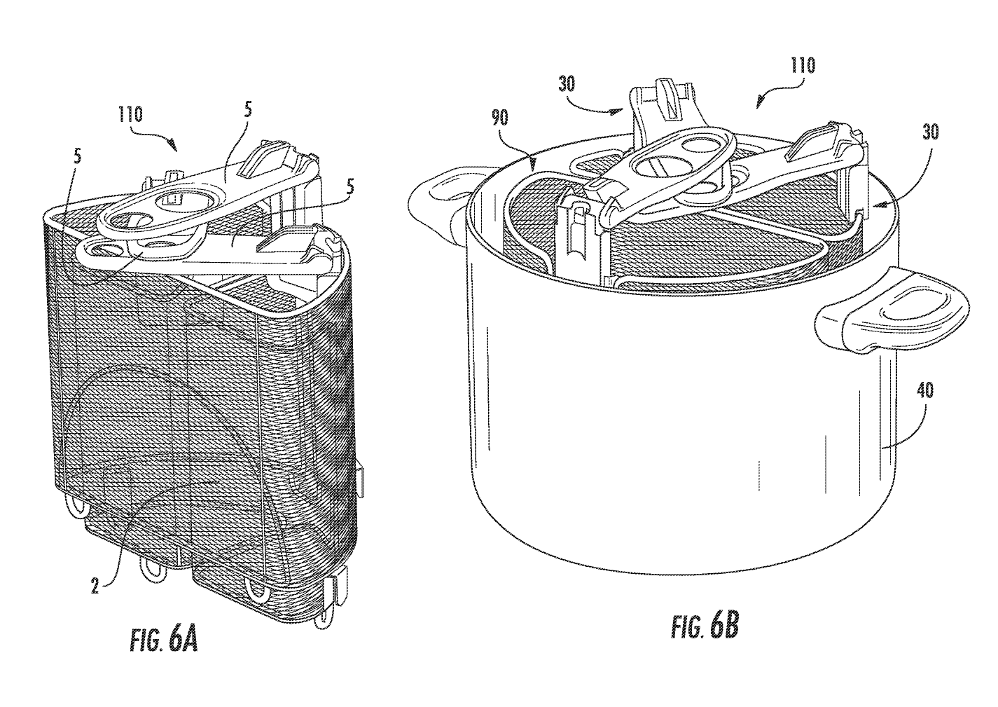

Referring now to FIG. 6A, a set of perforated vessels 110 with foldable handles is shown with several smaller perforated vessels inserted inside another, larger perforated vessel. With the smaller perforated vessels located inside the larger perforated vessel, the amount of space occupied by the vessels is reduced. FIG. 6A shows how perforated vessels of different dimensions can be inserted one inside the other in such a way that multiple perforated vessels can be arranged inside the larger one. As shown in FIG. 6A, the handles 5 of each vessel may be folded inwardly further reducing the space occupied by the set 110 during storage and transportation. In the exemplary embodiment of FIG. 6A, set 110 is shown including two perforated vessels of a quarter-circular shape inserted inside a larger perforated vessel of a semi-circular shape.

In one embodiment according to FIG. 6A, the bottom wall 2 of the larger semi-circular perforated vessel is placed in an open storage position. As shown, in the open storage position, bottom wall 2 is rotated about hinges 3 such that bottom wall 2 is positioned within the interior of the vessel and is parallel to the planar sidewall of the vessel. In this position, the smaller vessels are permitted to extend through the larger vessel. In another embodiment, bottom wall 2 may be positioned along the outer surface of the planar sidewall of the semi-circular vessel in the storage position. With the smaller vessels located within the larger vessel, the handles of each perforated vessel are then folded one on top of the other. According to various exemplary embodiments, any number of perforated vessels of any shape may be inserted in the larger vessel, as long as all the perforated vessels can be contained within the larger one.

In an embodiment according to FIG. 6C, the bottom wall 2 of the larger semi-circular perforated vessel is placed in a closed storage position. As shown, in the closed storage position, bottom wall 2 is engaged by latch 6 in a closed position. In this position, the smaller vessels will nest within the larger vessel for storage, without falling through the open bottom wall. The handles of each perforated vessel may then be folded one on top of the other for storage. According to various exemplary embodiments, any number of perforated vessels of any shape may be inserted in the larger vessel, as long as all the perforated vessels can be contained within the larger one.

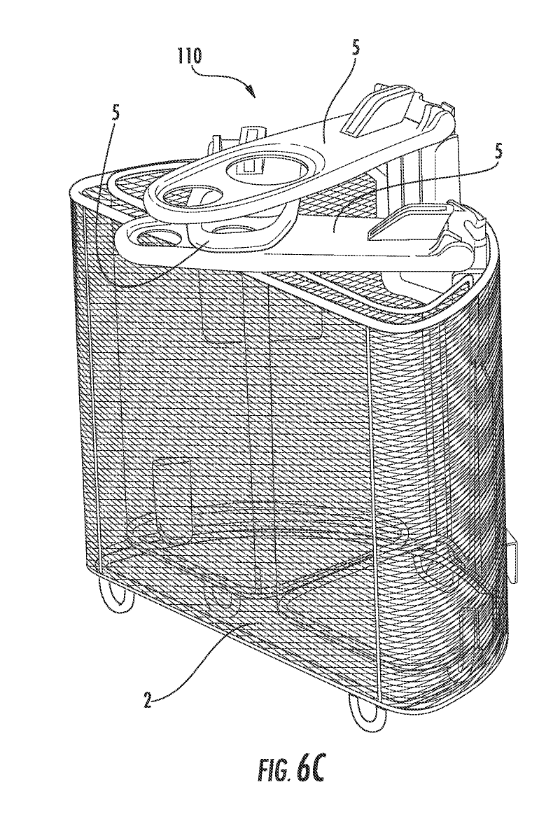

Referring now to FIG. 6B and FIG. 7, the set of perforated vessels 110 are shown located within a cooking vessel 40 (e.g., pot, pan, sauce pan, stock pot, dutch oven, etc.) within which the water is heated for cooking. In the embodiment shown, set 110 includes one perforated vessel 90 and two perforated vessels 30. When a set of such perforated vessels are used together in the same cooking vessel 40, individual portions of food located within each perforated vessel of set 110 remain separated within cooking vessel 40 during cooking. Further, each individual perforated vessel of set 110 can be retrieved or removed from cooking vessel 40 at different times to allow for different cooking times for the food within each vessel. In the exemplary embodiment of FIG. 6B and FIG. 7, set 110 includes one semi-circular vessel and two quarter-circular vessels located within cooking vessel 40, thus, creating three separate or segregated cooking sections within cooking vessel 40. If multiple perforated vessels are used in the same cooking vessel, each individual perforated vessel, and each individual portion of food within the vessel, can be separated from the boiling water without interrupting the cooking time of portions of food contained in other perforated vessels. This arrangement allows for cooking different kinds of food (e.g., pasta or vegetables), as well as the same type of food according to individual preferences, in parallel in the same cooking vessel. Such parallel cooking may reduce energy or water usage.

The handles 5 are coupled to the upper end of the sidewalls of the perforated vessels by mounts 52 and 53 (as shown in FIGS. 2A and 2B) such that the perforated vessels remain fully immersed in the water contained in the cooking vessel 40, while allowing the handles 5 to extend outside the cooking vessel 40 for a variety of cooking vessels having a range of different internal heights. This arrangement allows the perforated vessels to be employed as an accessory over a wide range of existing domestic stock pots or other cooking vessels of different height and diameters. When the handles of the perforated vessels are folded as shown in FIG. 6B, the perforated vessels will fit in the cooking vessel 40 for storage without handles 5 extending radially beyond the wall of the cooking vessel 40.

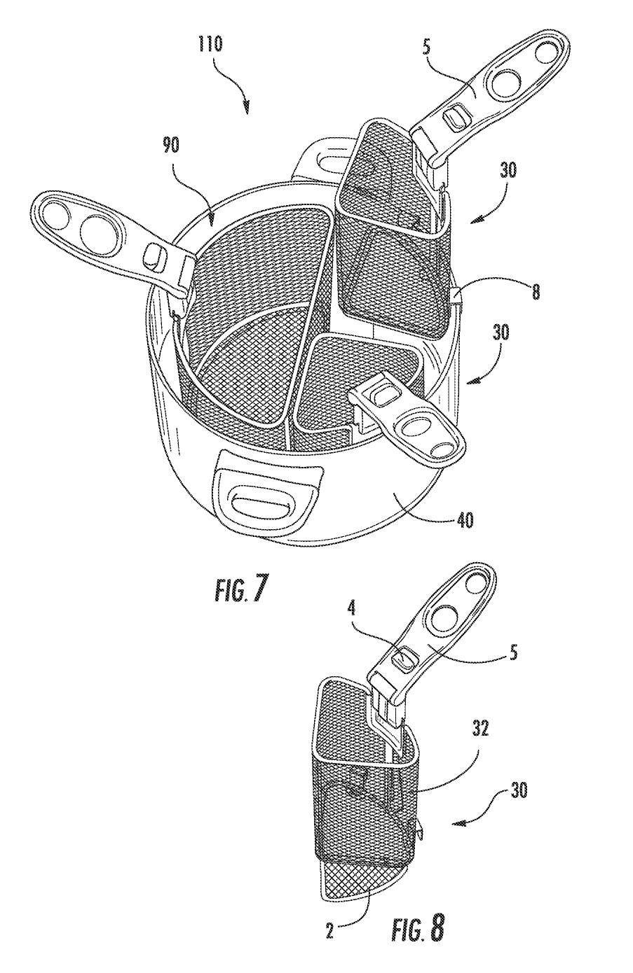

When the food in a perforated vessel is deemed ready, the perforated vessel can be lifted by its handle 5 vertically over the cooking vessel, and two or more hooks 8 may attach to the rim of the cooking vessel 40, allowing the perforated vessel to be suspended over the cooking vessel. For example, FIG. 7 shows a quarter-circular vessel 30 supported by hooks 8 from the upper rim of cooking vessel 40. In this position, the hot water can drain back into the cooking vessel from the perforated vessel 30. Because hot water may be drained from vessel 30 prior to moving the vessel 30 from above the cooking vessel 40, the possibility of spilling or splashing hot water on people or objects may be reduced. FIG. 8 shows one of the quarter-circular perforated vessels 30 following removal from cooking vessel 40 and following operation of button 4 to open bottom wall 2. As discussed above, food located within the interior chamber defined by sidewall 32 may be dispensed through the opening at the lower end of sidewall 32 with bottom wall 2 in the open position.

The construction and arrangement of the devices and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. Other substitutions, modifications, changes, and omissions may be made in the design, operating conditions and arrangement of the exemplary embodiments without departing from the scope of the present disclosure.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

Other embodiments are set forth in the following claims.

What is claimed is:

1. A device comprising:
a sidewall having an upper end and a lower end, the sidewall defining an interior chamber and the lower end of the sidewall defining a lower opening;
a perforated bottom wall coupled to the lower end of the sidewall, the bottom wall moveable between:
a closed position in which the perforated bottom wall is configured to block the lower opening to maintain an item within the interior chamber; and
an open position in which the bottom wall is configured to permit dispensing of the item from the interior chamber; and
a control operative to cause the bottom wall to move from the closed position to the open position;
wherein the device is a cooking device and the item is an edible item.

2. The device of claim 1, wherein the sidewall and the bottom wall comprise a material selected from the group consisting of a metal mesh, plastic mesh, perforated metal and perforated plastic.

3. The device of claim 1 further comprising at least one hook extending from the sidewall configured to engage the rim of a cooking vessel.

4. The device of claim 1 further comprising at least one foot extending below the bottom wall configured to support and separate the bottom wall of the device from a bottom of a cooking vessel.

5. The device of claim 1 further comprising a handle rotatably coupled to the sidewall such that the handle may be folded in the radial direction about the sidewall.

6. The device of claim 5 further comprising at least one hole defined in the handle, the hole sized to measure a serving of the edible item.

7. The device of claim 6, wherein the serving of the edible item comprises a serving of pasta.

8. The device of claim 1, wherein the bottom wall is coupled to the sidewall via a hinge.

9. The device of claim 8 further comprising a latch extending longitudinally along the sidewall, the latch having a lower end and an upper end, wherein the lower end of the latch engages the bottom wall and the control engages the upper end of the latch when operated to cause the lower end of the latch to disengage from the bottom wall, and further wherein the bottom wall rotates about the hinge to move from the closed position to the open position when the lower end of the latch disengages from the bottom wall.

10. The device of claim 9, wherein the control comprises a button and an actuator that engages the upper end of the latch when operated by the user.

11. The device of claim 10, wherein the button includes a spring that biases the actuator away from engagement with the latch.

12. The device of claim 11, wherein the spring, the button and the actuator are formed of an integral piece of material.

13. A set of devices for holding food during cooking, comprising:
a first device comprising:
a sidewall having an upper end and a lower end, the sidewall defining an interior chamber and the lower end of the sidewall defining a lower opening;
a perforated bottom wall coupled to the lower end of the sidewall, the bottom wall moveable between:
a closed position in which the bottom wall blocks the lower opening maintaining food within the interior chamber; and
an open position in which the bottom wall permits dispensing of food from the interior chamber; and
a control operative to cause the bottom wall to move from the closed position to the open position; and
a second device comprising:
a sidewall having an upper end and a lower end, the sidewall defining an interior chamber and the lower end of the sidewall defining a lower opening;
a perforated bottom wall coupled to the lower end of the sidewall, the bottom wall moveable between:
a closed position in which the bottom wall blocks the lower opening maintaining food within the interior chamber; and
an open position in which the bottom wall permits dispensing of food from the interior chamber; and
a control operative to cause the bottom wall to move from the closed position to the open position;
wherein the sidewall of the first device is sized such that the sidewall of the second device fits within the interior chamber of the first device.

14. The set of devices of claim 13, wherein the sidewall of the first device is substantially semi-circular in shape and the sidewall of the second device is substantially quarter-circular in shape.
